(19) United States
(12) Patent Application Publication
(10) Pub. No.: US 2018/0142917 A1
(43) Pub. Date: May 24, 2018

(54) Air Conditioner Circulation Apparatus with Environmental Protection and High Efficiency

(71) Applicant: Yao-Tsung Kao, Tainan City (TW)

(72) Inventor: Yao-Tsung Kao, Tainan City (TW)

(21) Appl. No.: 15/355,107

(22) Filed: Nov. 18, 2016

(51) Int. Cl. F24F 13/22; F24F 13/28; F24F 1/00; F24F 1/02; B01D 53/04

(52) U.S. Cl. CPC F24F 13/222; F24F 13/28; F24F 13/224; F24F 1/0003; B01D 2253/102; F24F 1/027; B01D 53/0407; F24F 2013/225; F24F 1/025

(57) ABSTRACT

An air conditioner circulation apparatus includes a receiving tank (2) provided with an air channel (22), an active carbon (3) mounted in the receiving tank, and an air blower housing (4) connected to the air channel. The receiving tank collects water drained from an air conditioner. A hot air drained from the air conditioner is sucked into the air blower housing, and is delivered through the air channel into the bottom of the receiving tank. The active carbon filters impurities in the hot air. The water collected in the receiving tank cools and returns the hot air into a cooled air which has a normal temperature, and purifies the cooled air to release a clean air. Thus, the water and the hot air drained from the air conditioner are removed, and the fresh clean air is generated.

### BACKGROUND OF THE INVENTION

### 1. Field of the Invention

The present invention relates to a circulation apparatus and, more particularly, to an air conditioner circulation apparatus.

### 2. Description of the Related Art

A conventional air conditioner transfers a hot air into a cold air which is delivered into the indoor room so as to provide an air conditioning effect to the user in the indoor room. The conventional air conditioner produces water and hot air during operation. The water is introduced into a drain pipe and is drained out of the air conditioner. The hot air is directly drained into the ambient environment. However, the hot air decreases the air quality and increases the temperature of the earth, thereby easily causing an environmental pollution.

### BRIEF SUMMARY OF THE INVENTION

The primary objective of the present invention is to provide an air conditioner circulation apparatus with environmental protection and high efficiency.

In accordance with the present invention, there is provided an air conditioner circulation apparatus comprising a receiving tank having a side provided with an air channel, an active carbon mounted in the receiving tank, and an air blower housing provided with a bent pipe which is connected to the air channel. The receiving tank collects water drained from an air conditioner. A hot air drained from the air conditioner is sucked into the air blower housing, and is delivered through the bent pipe and the air channel into a bottom of the receiving tank. The active carbon filters impurities in the hot air. The water collected in the receiving tank cools and returns the hot air into a cooled air which has a normal temperature, and purifies the cooled air to release a clean air.

Preferably, the air conditioner circulation apparatus further comprises a support board or a plurality of support bars mounted in the receiving tank, and the active carbon is supported by the support bars, with a space being defined between the active carbon and the bottom of the receiving tank.

Preferably, the active carbon replaceable.

Preferably, the air channel has a bottom provided with an oblique face.

Preferably, the air conditioner is a window air conditioner, a mobile air conditioner or a host of a split air conditioner.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a conventional window air conditioner.

FIG. 2 is a perspective view of a mobile air conditioner.

FIG. 3 is a perspective view of a receiving tank of the air conditioner circulation apparatus in accordance with the preferred embodiment of the present invention.

FIG. 4 is a perspective view of an air blower of the air conditioner circulation apparatus in accordance with the preferred embodiment of the present invention.

FIG. 5 is a cross-sectional operational view of the air conditioner circulation apparatus in accordance with the preferred embodiment of the present invention.

### DETAILED DESCRIPTION OF THE INVENTION

An air conditioning system includes a window air conditioner, a mobile air conditioner and a split air conditioner. The split air conditioner has a host. The principles of the window air conditioner, the mobile air conditioner and the host of the split air conditioner are similar and will not be further described in detail.

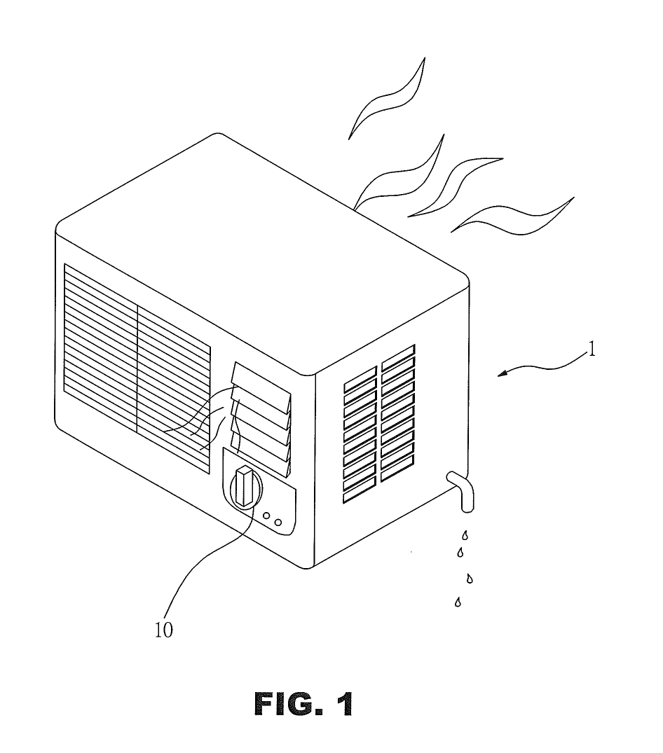

Referring to the drawings and initially to FIG. 1, an air conditioner 1 comprises a switch 10. The air conditioner 1 is a conventional window air conditioner comprising a compressor, a condenser, an evaporator and a refrigerant, which are conventional arrangements and will not be further described in detail.

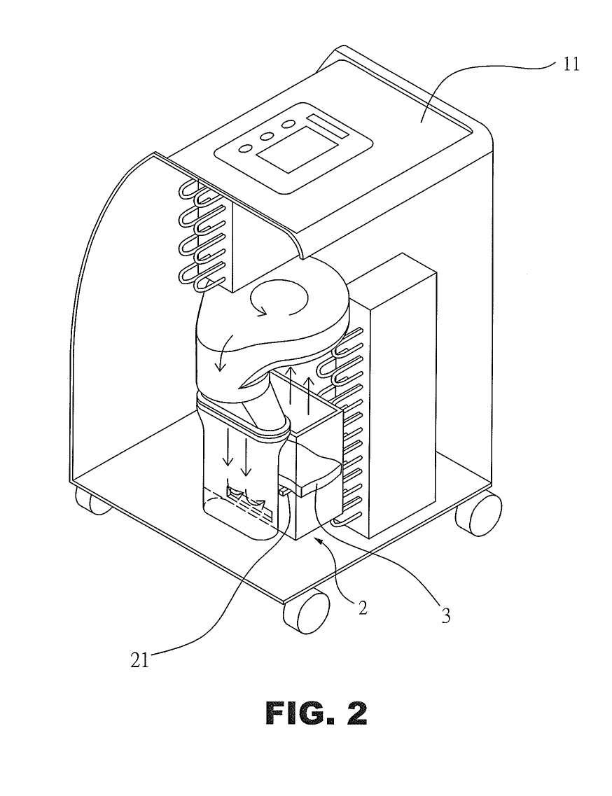

Referring to FIG. 2, a mobile air conditioner 11 comprises a receiving tank 2, a support board or a plurality of support bars 21, and an active carbon 3. The receiving tank 2 is the design point of the present invention. The receiving tank 2 collects water and hot air drained from the mobile air conditioner 11. The hot air enters the receiving tank 2, and is cooled by the water in the receiving tank 2. Then, the active carbon 3 filters and purifies the cooled air to release a clean air. Thus, the two pollution sources, that is, the water and the hot air, produced by the mobile air conditioner 11 are cleared completely.

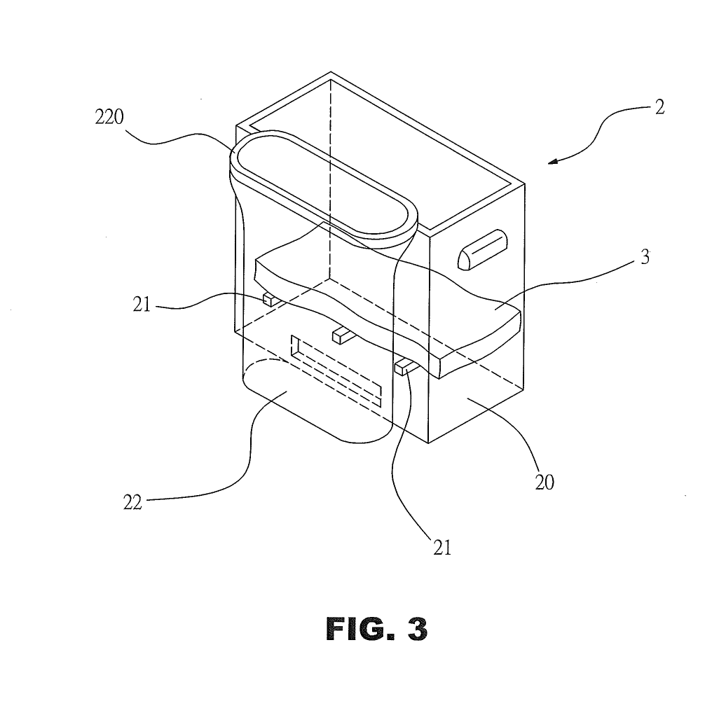

Referring to FIG. 3, the support bars 21 are mounted in a lower portion of the receiving tank 2, and the active carbon 3 is supported by the support bars 21. A space 20 is defined between the active carbon 3 and the bottom of the receiving tank 2. Alternatively, when the support bars 21 are not provided, the active carbon 3 is directly placed on the bottom of the receiving tank 2. The receiving tank 2 has a side formed with an air channel 22. The air channel 22 has a bottom connected to the receiving tank 2 and has an upper end formed with a connector 220.

Again referring to FIGS. 1 and 3, when air conditioner 1 is started, the compressor compresses the refrigerant (not shown) to have high temperature and high pressure. Then, the refrigerant is condensed by the condenser to have a liquid state. Then, the refrigerant is evaporated by the evaporator to achieve a heat absorbing effect, and to deliver a cold air into the room. Thus, operation of the compressor produces cold air. At this time, operation of the compressor also produces water and hot air. In the preferred embodiment of the present invention, the water is directly collected in the receiving tank 2, and the hot air is pushed by a pressure (such as by an air blower) to enter the bottom of the receiving tank 2, so that the receiving tank 2 collects the water and the hot air drained from the air conditioner. At this time, the hot air is cooled by the water in the receiving tank 2. Then, the active carbon 3 filters and purifies the cooled air to release a clean air at a normal temperature, to prevent from producing pollution.

In such a manner, the air conditioner circulation apparatus in accordance with the present invention uses the energy conservation law, so that when the air conditioner produces the water and the cold air, the receiving tank 2 collects the water, and the cold air is forced to enter the bottom of the receiving tank 2, is cooled by the water in the receiving tank 2, is cleaned and purified by the active carbon 3, is returned to the normal temperature, and is transferred to the clean air which is released and drained outward.

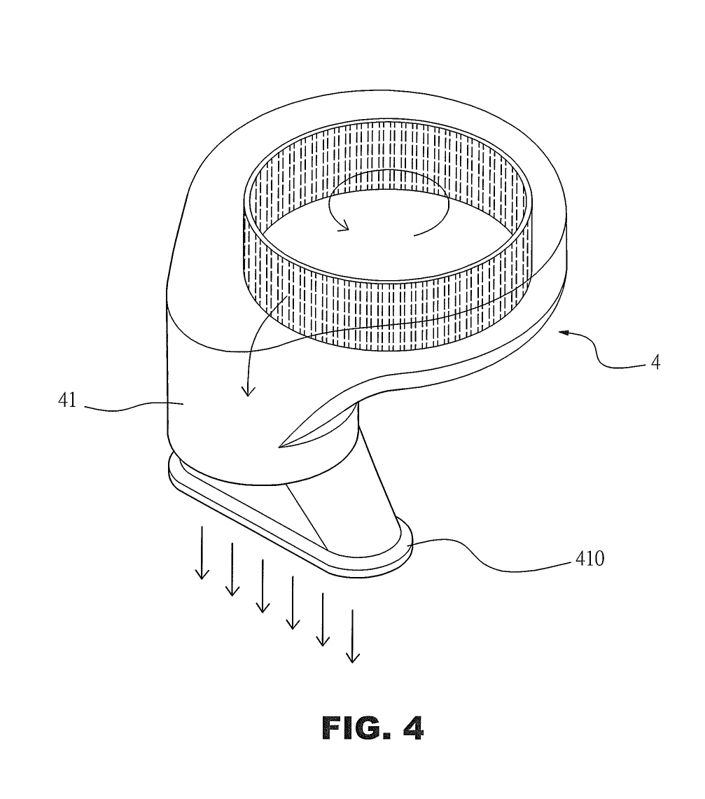

Referring to FIG. 4, an air blower housing 4 is used to blow the hot air. The air blower housing 4 is provided with a bent pipe 41 which has a bottom provided with a connecting head 410 connected with the connector 220 of the air channel 22 of the receiving tank 2. Thus, the hot air is pushed by the air blower to enter the bottom of the receiving tank 2.

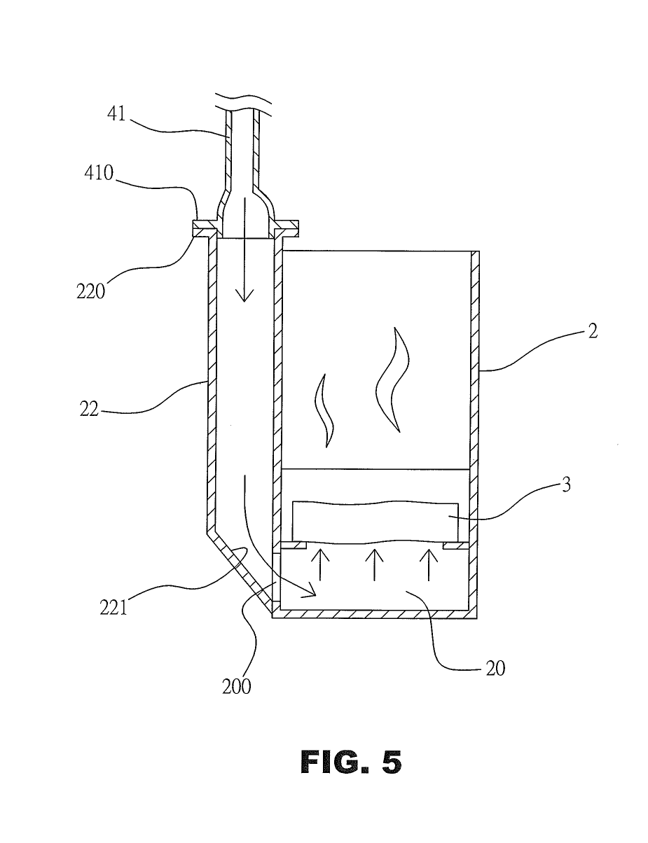

Referring to FIG. 5, the receiving tank 2 is provided with a connecting hole 200 connected between the air channel 22 and the space 20. The bottom of the air channel 22 is provided with an oblique face 221 to guide and introduce the hot air into the space 20 of the receiving tank 2 quickly. In the conventional air conditioner, the air blower housing 4 drains the hot air outward from the air conditioner. In the air conditioner of the present invention, the hot air is delivered through the bent pipe 41 and the air channel 22 into the bottom of the receiving tank 2. Then, the water in the receiving tank 2 cools the hot air and pushes the cooled air upward, and the active carbon 3 filters and purifies the cooled air to release a clean air which is directly discharged into the room.

Moreover, in the conventional air conditioner, the inner working temperature is very high, thereby decreasing the output efficiency of sending the cold air, and thereby wasting the energy. In the air conditioner of the present invention, the hot air is collected, is cooled to reduce its temperature, and is returned to an original condition, so that the inner temperature of the air conditioner is lowered, thereby increasing the output efficiency of sending the cold air, and thereby saving the energy and electricity, so as to satisfy the requirement of the environmental protection.

Accordingly, the inner temperature of the air conditioner is reduced so that the air conditioner circulation apparatus has a high frequency so as to enhance the air conditioning effect. In addition, the drained water and the active carbon 3 are used to cool, filter, purify and return the drained hot air so as to release the clean air. Further, the air conditioner circulation apparatus is mounted conveniently without needing an arrangement to drain the water and the hot air. Further, the receiving tank 2 collects water and hot air drained from the compressor, and the hot air evaporates the water in the receiving tank 2, thereby overcoming the problem of water overflow. Further, the drained water and the active carbon 3 are used to transfer the drained hot air into the clean air, so as to decrease the greenhouse effect, and to satisfy the requirement of the environmental protection.

In conclusion, the air conditioner circulation apparatus in accordance with the present invention includes four features as follows:
(1) living: the air conditioner circulation apparatus produces the clean air which is the living source of the mankind;
(2) delivery: the air conditioner forms a circulation by operation of the compressor to generate cold air, water and hot air;
(3) guidance: the water and the hot air are introduced into the receiving tank 2 which cooperates the active carbon 3 to provide water absorbing, cooling and purifying effects; and
(4) burning: the hot air is cooled, purified and returned to release the clean air.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An air conditioner circulation apparatus comprising:
a receiving tank having a side provided with an air channel;
an active carbon mounted in the receiving tank; and
an air blower housing provided with a bent pipe which is connected to the air channel;
wherein:
the receiving tank collects water drained from an air conditioner;
a hot air drained from the air conditioner is sucked into the air blower housing, and is delivered through the bent pipe and the air channel into a bottom of the receiving tank;
the active carbon filters impurities in the hot air;
the water collected in the receiving tank cools and returns the hot air into a cooled air which has a normal temperature, and purifies the cooled air to release a clean air.

2. The air conditioner circulation apparatus of claim 1, wherein the air conditioner circulation apparatus further comprises a support board or a plurality of support bars mounted in the receiving tank, and the active carbon is supported by the support bars, with a space being defined between the active carbon and the bottom of the receiving tank.

3. The air conditioner circulation apparatus of claim 1, wherein the active carbon replaceable.

4. The air conditioner circulation apparatus of claim 1, wherein the air channel has a bottom provided with an oblique face.

5. The air conditioner circulation apparatus of claim 1, wherein the air conditioner is a window air conditioner, a mobile air conditioner or a host of a split air conditioner.
